(19) United States
(12) Patent Application Publication
(10) Pub. No.: US 2026/0086285 A1
(43) Pub. Date: Mar. 26, 2026

(54) PHOTONIC INTERCONNECT AND METHOD FOR MANUFACTURING SAME

(71) Applicant: Panasonic Intellectual Property Management Co., Ltd., Osaka (JP)

(72) Inventors: AYA KUROKAWA, Tottori (JP); DAISUKE SAKURAI, Osaka (JP); KIYOKAZU ITOI, Osaka (JP); TAKAHIRO KUMAKAWA, Kyoto (JP); KOJIRO NAKAMURA, Osaka (JP)

(21) Appl. No.: 19/404,529

(22) Filed: Dec. 1, 2025

Related U.S. Application Data
(63) Continuation of application No. PCT/JP2024/013708, filed on Apr. 3, 2024.

(30) Foreign Application Priority Data
Jun. 5, 2023 (JP) 2023-092499

(51) Int. Cl. G02B 6/124; G02B 6/13

(52) U.S. Cl. CPC G02B 6/124; G02B 6/13

(57) ABSTRACT

An photonic interconnect that is formed in an photonic device having an optical waveguide and transmits light emitted from a optical input and output portion included in the optical waveguide includes a connection portion connected to the optical waveguide and a transmission line portion extending from the connection portion. The connection portion is connected to the optical waveguide while avoiding the optical input and output portion, and is wider than the transmission line portion.

### TECHNICAL FIELD

The present disclosure relates to an photonic interconnect that transmits light of an photonic interconnect on an element, and a method for manufacturing the photonic interconnect.

### BACKGROUND ART

For high-speed and large-capacity digital communication, optical communication modules have been put into practical use in many fields instead of electrical communication modules that transmit electrical signals.

The optical communication module is required to have a function of converting an input electrical signal into an optical signal and transmitting the optical signal, and a function of receiving an optical signal from an optical fiber, restoring the optical signal to an electrical signal, and outputting the electrical signal. A light emitting element such as a light emitting diode (LED) or a vertical cavity surface emitting laser (VCSEL) is used for transmitting an optical signal, and a light receiving element such as a photo diode (PD) is used for receiving an optical signal. The light emitting element and a drive circuit are electrically connected. Similarly, the light receiving element and an amplifier circuit are electrically connected.

As technique for efficiently coupling optical fibers, photoelectric conversion elements, and the like, an optical interconnection technique for performing hybrid integration using an optical waveguide device has attracted attention.

For example, in Patent Literature 1, an photonic interconnect is formed using a thermoplastic material. In Patent Literature 1, an arch-shaped photonic interconnect connecting a first optical transmission end to a second optical transmission end in an optical circuit is formed along a shape of a silicon base body. At this time, a capillary which has a double tube structure in which a thermoplastic core material and a thermoplastic clad material are supplied from different tanks and is movable in a three-dimensional direction is used. While such a capillary is moved along the base body, the core material and the clad material are heated, injected, and solidified to perform wiring.

### CITATION LIST

### Patent Literature

PTL 1: Unexamined Japanese Patent Publication No. H10-68836

### SUMMARY OF THE INVENTION

In the method of PTL 1, the diameter of the photonic interconnect becomes small, and the connection strength at the connection portion between the photonic device and the photonic interconnect tends to be weak. That is, the connection is easily disconnected by a small impact or the like.

An object of the present disclosure is to suppress disconnection between an photonic interconnect and an photonic device due to vibration, impact, or the like at the time of carrying the photonic interconnect or at the time of use.

The photonic interconnect of the present disclosure is formed in an photonic device having an optical waveguide, and transmits light emitted from a optical input and output portion included in the optical waveguide. The photonic interconnect includes a connection portion connected to the optical waveguide, and a transmission line portion extending from the connection portion. The connection portion is connected to the optical waveguide while avoiding the optical input and output portion, and is wider than the transmission line portion.

An optical transmission module of the present disclosure includes the photonic device having the optical waveguide, and the photonic interconnect of the present disclosure.

A method for manufacturing the photonic interconnect of the present disclosure is a method for manufacturing the photonic interconnect that is formed in the photonic device having the optical waveguide and transmits light emitted from the optical input and output portion of the optical waveguide. The method includes a feeding step of feeding liquid resin materials while moving a material feeder, and a curing step of sequentially curing the fed resin materials to cure the resin materials in a wire shape extending in the air.

According to the photonic interconnect of the present disclosure, since the connection portion connected to the optical waveguide while avoiding the optical input and output portion has a wider width than the transmission line portion, the strength of connection is improved. This suppresses disconnection between the photonic device and the photonic interconnect due to impact or the like. According to the method for manufacturing the photonic interconnect of the present disclosure, the photonic interconnect of the present disclosure can be manufactured.

### BRIEF DESCRIPTION OF THE DRAWINGS

FIG. 1 is a cross-sectional view schematically illustrating an optical transmission module of the present disclosure.

FIG. 2 is a plan view corresponding to the optical transmission module of FIG. 1.

FIG. 3 is a cross-sectional view schematically illustrating the optical transmission module according to a first modification of the present disclosure.

FIG. 4 is a plan view corresponding to the optical transmission module of FIG. 3.

FIG. 5 is a cross-sectional view schematically illustrating the optical transmission module according to a third modification of the present disclosure.

FIG. 6 is a plan view corresponding to the optical transmission module of FIG. 5.

FIG. 7 is a view for describing a method for manufacturing the photonic interconnect of the present disclosure using the optical transmission module of FIG. 1 as an example.

FIG. 8 is a view illustrating a first sequence example when the photonic interconnect of the present disclosure is manufactured.

FIG. 9 is a view illustrating a second sequence example when the photonic interconnect of the present disclosure is manufactured.

FIG. 10 is a view illustrating a third sequence example when the photonic interconnect of the present disclosure is manufactured.

### DESCRIPTION OF EMBODIMENT

Hereinafter, exemplary embodiments will be described with reference to the drawings. The following description is illustrative and not restrictive. In addition, changes can be made as appropriate within a range in which the effects are exhibited.

### Configuration of Photonic Interconnect

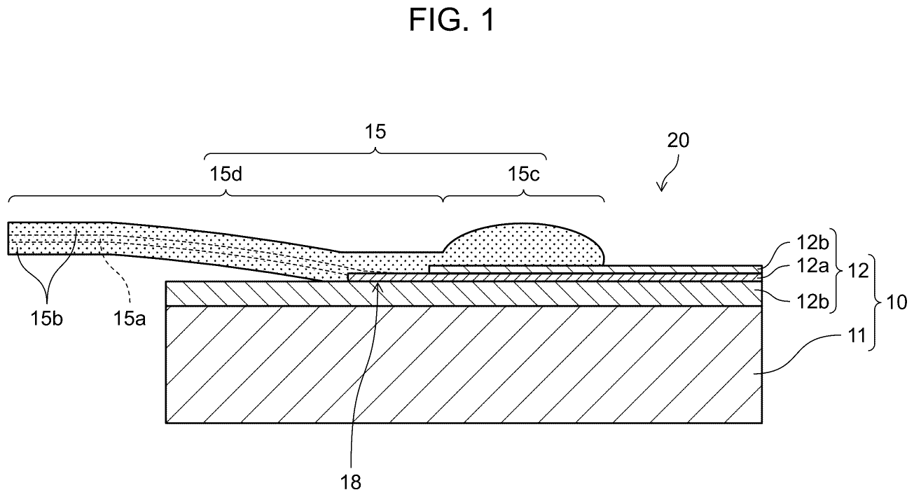

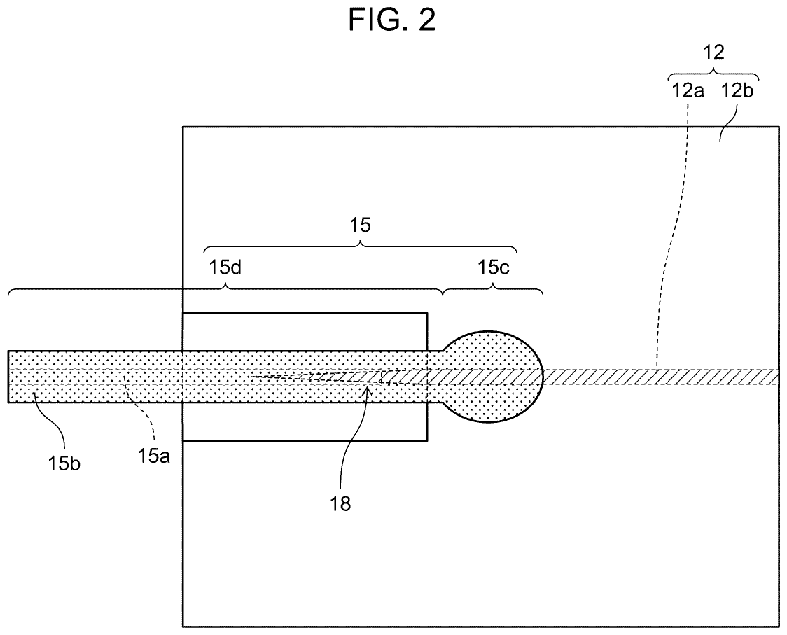

FIG. 1 is a cross-sectional view schematically illustrating optical transmission module 20 according to an exemplary embodiment of the present disclosure, and FIG. 2 is a schematic plan view of optical transmission module 20 as viewed from above in FIG. 1.

As illustrated in FIGS. 1 and 2, optical transmission module 20 includes photonic device 10 and photonic interconnect 15. Photonic interconnect 15 is optically connected to optical waveguide 12 included in photonic device 10.

Connection portion 15c of photonic interconnect 15 is wider than transmission line portion 15d extending from the connection portion and has a drop shape. As a result, a connection area between connection portion 15c and optical waveguide 12 increases, and disconnection due to impact or the like is suppressed. In the example of FIG. 1, connection portion 15c has a shape bulging with roundness also in the thickness direction.

In addition, since connection portion 15c is arranged to avoid optical input and output portion 18 in photonic device 10, an adverse effect on the optical connection between optical waveguide 12 and photonic interconnect 15 is avoided.

These will be further described below.

Photonic device 10 is, for example, a light emitting element such as a laser, a light receiving element such as a photodiode, silicon photonics (SiPh), a planar lightwave circuit (PLC), an optical fiber, or the like, and may be made of Si wafer, GaAs, or the like. In addition, photonic device 10 may be, for example, a planar lightwave circuit made of a quartz glass thin film deposited on a silicon substrate.

Photonic device 10 includes substrate 11 and optical waveguide 12 provided on substrate 11. Optical waveguide 12 includes first cladding layer 12b and first core layer 12a wrapped in first cladding layer 12b. In the present exemplary embodiment, first cladding layer 12b is formed so as to cover the upper surface of substrate 11. For example, first core layer 12a having a diameter of 2 μm to 3 μm is formed so as to be embedded inside first cladding layer 12b.

As illustrated in FIG. 2, first core layer 12a in optical waveguide 12 has a tapered shape in which the distal end is narrowed. In addition, first cladding layer 12b in the region including the tapered shape portion is removed, and first core layer 12a is exposed. As a result, optical input and output portion 18 in which light leaks out of optical waveguide 12 from first core layer 12a of the tapered shape portion is configured.

First core layer 12a is formed by patterning a surface silicon layer of a silicon on insulator (SOI) substrate using, for example, a photolithography technique, an etching technique, or the like. First cladding layer 12b is formed on substrate 11 using silicon oxide (SiO₂) as a material by using a known deposition technique such as plasma CVD, for example.

As the configuration of optical waveguide 12, in addition to the above, a semiconductor such as quartz glass, a polymer which is an organic substance, Si, silicon nitride (SiN), gallium arsenide, or indium phosphide (InP) may be used as a material.

Note that, although only one first core layer 12a (and optical input and output portion 18 at the end of the first core layer) is illustrated in FIG. 2, a plurality of first core layers 12a may be formed in photonic device 10, and photonic interconnect 15 may be provided for each first core layer.

Next, photonic interconnect 15 includes second core layer 15a made of resin through which light is transmitted and second cladding layer 15b covering second core layer 15a. Second core layer 15a is preferably made of a material having high transmittance at a wavelength of light input and output by optical waveguide 12.

Photonic interconnect 15 may have either a step index (SI) type structure or a graded index (GI) type structure. The SI type is a type in which an interface having a clear refractive index is formed between a core layer and a clad layer, and light is propagated by reflection at the interface. In addition, the-GI type is a type in which the refractive index is the highest at the center of the core layer, the refractive index gradually decreases toward the outside, and light is guided to the center of the core layer and propagates. Here, in the GI-type, crosstalk does not occur even when the pitch between the cores is reduced. In addition, theoretically, propagation loss due to interface reflection does not occur. Therefore, a GI-type optical waveguide is desirable for an optical-electrical mixed substrate in which an optical waveguide having a high density and a long distance is required. However, the technique of the present disclosure is also applicable to the SI type.

Connection portion 15c of photonic interconnect 15 includes second cladding layer 15b and is connected onto first cladding layer 12b of optical waveguide 12. Connection portion 15c has a drop shape bulging wider than transmission line portion 15d. Therefore, the connection area is increased, and the strength of connection between connection portion 15c and first cladding layer 12b is increased. Note that connection portion 15c bulges both in width and thickness larger than the diameter of transmission line portion 15d.

In addition, connection portion 15c is connected while avoiding the upper part of optical input and output portion 18 of photonic device 10. As a result, photonic interconnect 15 and optical waveguide 12 are physically connected to each other (transmission line portion 15d can also partially contribute to physical connection). In addition, second core layer 15a in photonic interconnect 15 is formed such that the distal end of the second core layer is connected to first core layer 12a in optical waveguide 12. As a result, optical waveguide 12 and photonic interconnect 15 are optically connected to each other, and light is transmitted to each other.

As described above, second core layer 15a through which light passes in photonic interconnect 15 is connected to first core layer 12a of optical waveguide 12 to realize optical connection for transmitting light. In addition, connection portion 15c formed of second cladding layer 15b of photonic interconnect 15 spreads in a drop shape to secure a large connection area. As a result, as compared with a case where connection portion 15c is not provided and optical waveguide 12 is connected by transmission line portion 15d, the strength of the connection is improved, and it is possible to suppress a problem such as disconnection of photonic interconnect 15 due to an impact.

In photonic interconnect 15, the diameter of second core layer 15a is, for example, about 8 μm to 9 μm, and the diameter of second cladding layer 15b is, for example, about 120 μm.

Photonic interconnect 15 can be formed using a photocurable resin (a manufacturing method will be described later). The curing mechanism is not particularly limited to radical polymerization, cationic polymerization, or the like.

Examples of the material of second cladding layer 15b of photonic interconnect 15 include a bifunctional acrylate compound (for example, 2,2-bis [4-(acryloxydiethoxy) phenyl] propane), a radical generator (for example, tetra-n-butylammonium triphenyl-n-butylborate), and a photosensitizer dye reactive to an ultraviolet wavelength. In addition, examples of the material of second core layer 15a include a diimmonium dye of a photosensitizer dye reactive to an infrared wavelength, and the like, in addition to the above materials. Furthermore, the resin materials for forming second core layer 15a and second cladding layer 15b are preferably materials whose curing is accelerated even by heat.

### Modification Regarding Optical Transmission Module

The connection form between optical waveguide 12 and photonic interconnect 15 is not limited to that illustrated in FIGS. 1 and 2. Other examples of the connection form will be described below.

### First Modification

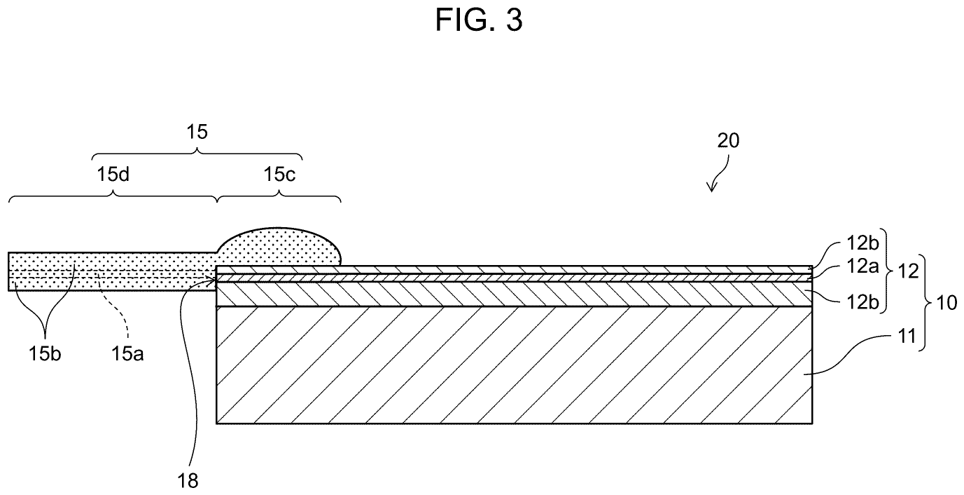

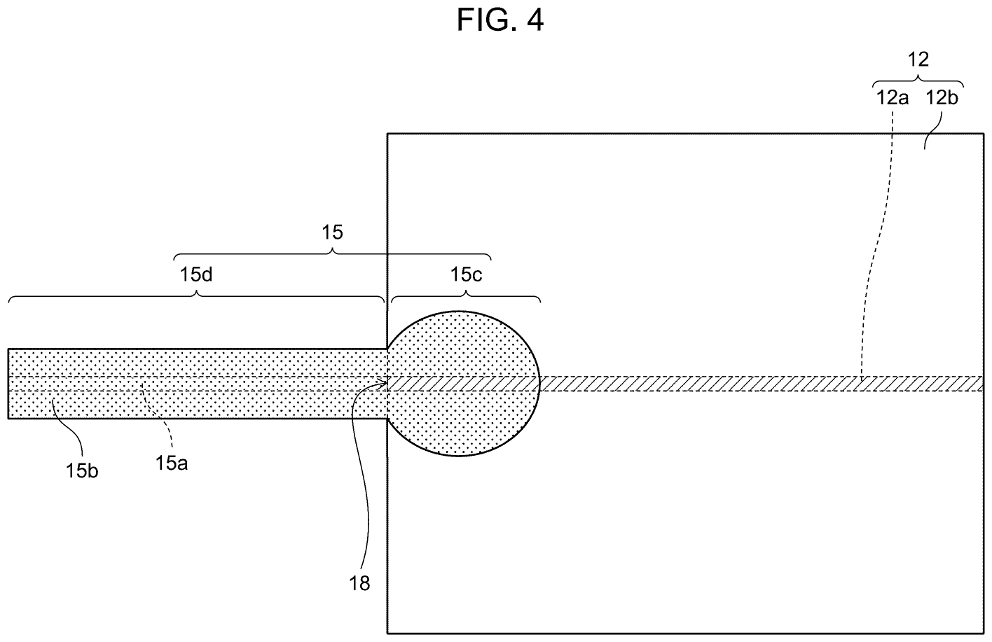

As a first modification, FIGS. 3 and 4 illustrate optical transmission module 20a constituting an edge coupler. In this example, similarly to optical transmission module 20 in FIGS. 1 and 2, photonic device 10 includes optical waveguide 12 provided on substrate 11, and optical waveguide 12 includes first cladding layer 12b and first core layer 12a.

However, in the present modification, first core layer 12a extends to an end surface of photonic device 10 in a state of being wrapped in first cladding layer 12b, and optical input and output portion 18 is formed at the distal end portion exposed to the end surface.

In addition, photonic interconnect 15 is formed to extend from the end surface at the position of optical input and output portion 18. At this time, connection portion 15c is connected to the upper surface of first cladding layer 12b in photonic device 10, has a width larger than that of transmission line portion 15d, and has a shape spreading in a drop shape. As a result, the strength of the connection is improved.

In addition, second core layer 15a is connected to first core layer 12a, and optical connection between optical waveguide 12 and photonic interconnect 15 is realized.

### Second Modification

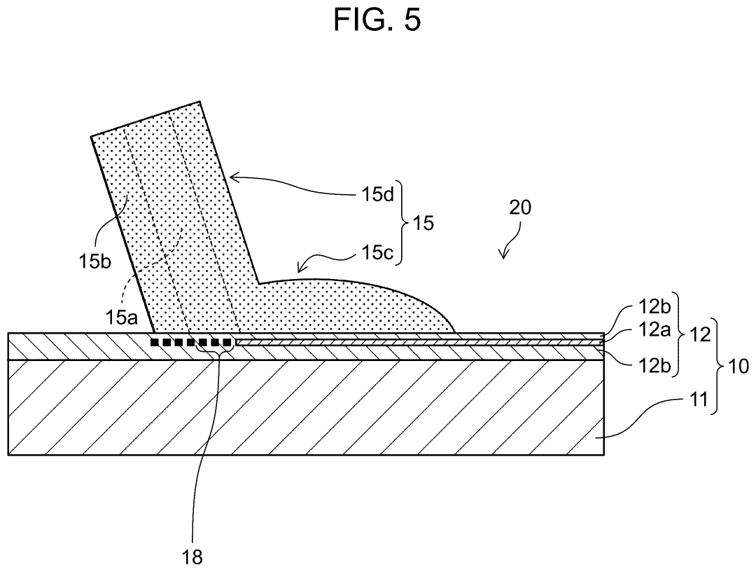

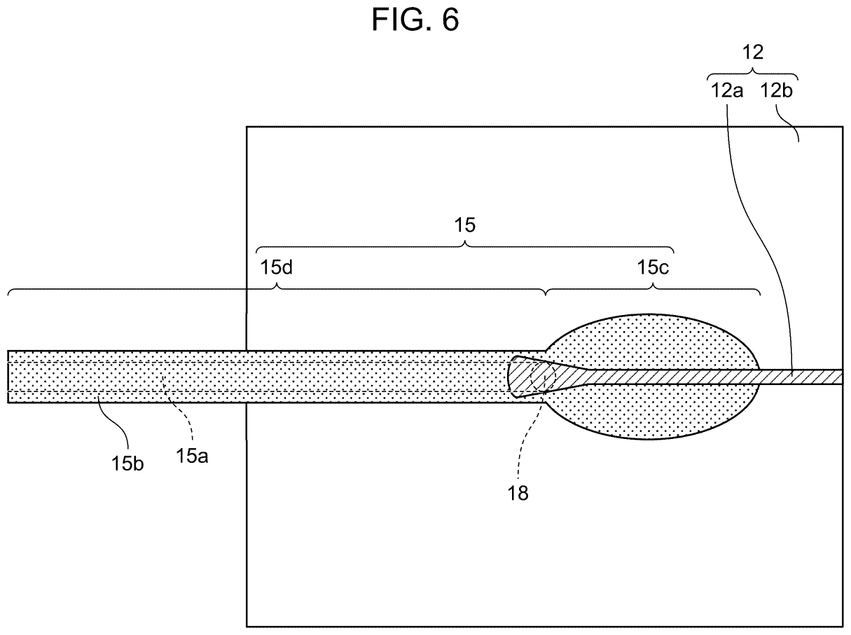

As a second modification, FIGS. 5 and 6 illustrate optical transmission module 20b constituting a grating coupler. Also here, similarly to optical transmission module 20 in FIGS. 1 and 2, photonic device 10 includes optical waveguide 12 provided on substrate 11, and optical waveguide 12 includes first cladding layer 12b and first core layer 12a.

In this example, a diffraction grating is provided at an end of first core layer 12a (In FIG. 5, the diffraction grating is illustrated by an arrangement of black squares. In FIG. 6, the diffraction grating is illustrated by a fan-shaped spread portion at the end of first core layer 12a), and optical input and output portion 18 through which light leaks in the diffraction grating is configured.

Photonic interconnect 15 is provided with transmission line portion 15d such that connection portion 15c is connected onto first cladding layer 12b while avoiding optical input and output portion 18, and second core layer 15a is connected to optical input and output portion 18. Even in such a configuration, the strength of the connection is improved by providing connection portion 15c having a shape spreading in a drop shape.

### Method for Manufacturing Photonic Interconnect

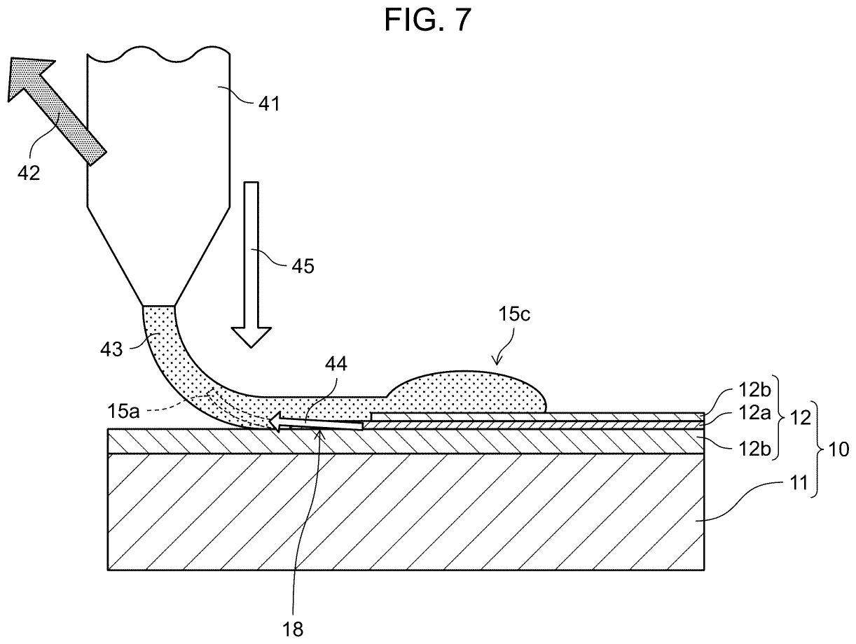

Next, a method for manufacturing photonic interconnect 15 of the present disclosure will be described. FIG. 7 illustrates a step of forming photonic interconnect 15 in photonic device 10 corresponding to FIG. 1. Note that, also in the modifications illustrated in FIGS. 3 to 6, the method for manufacturing photonic interconnect 15 is similar.

First, the summary is that, in the method of the present disclosure, capillary 41 (only the tip end is illustrated) is used as a material feeder in order to feed resin material 43 for forming photonic interconnect 15. Capillary 41 can discharge (feed) liquid resin material 43 from the distal end thereof while moving. As liquid resin material 43, a photocurable resin is used. In addition, in order to cure resin material 43, light 45 having the first wavelength emitted from the outside and light 44 having the second wavelength emitted from optical waveguide 12 are used.

Resin material 43 is discharged while the distal end of capillary 41 is moved, and light 45 having the first wavelength is emitted while the position of the focal point is moved in conjunction with the movement of capillary 41. In addition, light 44 having the second wavelength is emitted through optical waveguide 12. Discharged resin materials 43 are sequentially cured, and photonic interconnect 15 is formed according to the trajectory along which the distal end of capillary 41 moves. As a result, photonic interconnect 15 can be formed along another object, or can be formed in a wire shape extending in the air. Note that, as long as the resin is only cured in a wire shape extending in the air, the curing can be realized by using only light 45 having the first wavelength.

At this time, the periphery of photonic interconnect 15 is cured by light 45 having the first wavelength, and the central portion is cured by light 44 having the second wavelength. For this purpose, for example, the intensity of light 45 having the first wavelength is adjusted so as not to supply energy enough to cure entire resin material 43.

As described above, photonic interconnect 15 including second core layer 15a and second cladding layer 15b wrapping the second core layer is formed.

In addition, in order to more reliably fix photonic interconnect 15 to photonic device 10, connection portion 15c is formed at a position avoiding optical input and output portion 18. That is, the distal end of capillary 41 is arranged on first core layer 12a avoiding optical input and output portion 18, and the discharge of resin material 43 is started. At this time, resin material 43 is discharged more than when transmission line portion 15d is formed, and light 45 having the first wavelength is emitted. As a result, connection portion 15c having a width larger than that of transmission line portion 15d is formed. Connection portion 15c is formed of second cladding layer 15b.

Since connection portion 15c has a shape spreading in a drop shape, a large connection area is secured, and the reliability of fixing is improved. Therefore, highly reliable optical transmission module 20 is realized.

Note that, in order to reliably fix the photonic interconnect, conventionally, a resin material is applied and spread on the element so as to cover the distal end of the photonic interconnect fixed in accordance with the optical input and output portion. In this case, the loss of the resin material increases. In comparison, in the method of the present disclosure, the loss of the resin material is small, and the cost is reduced.

After connection portion 15c is formed, capillary 41 is moved so as to pass through photonic interconnect 15, and transmission line portion 15d connected to connection portion 15c is formed. Second core layer 15a is formed on the center side of transmission line portion 15d by light 44 having the second wavelength. Furthermore, capillary 41 is moved away from the upper surface of photonic device 10 (indicated by an arrow 42) to form transmission line portion 15d which is a portion extending in the air.

FIG. 7 illustrates second core layer 15a being formed in resin material 43 being discharged and cured. When a part of second core layer 15a is formed in resin material 43 in the vicinity of optical input and output portion 18, light 44 having the second wavelength is propagated by second core layer 15a, and second core layer 15a is further formed in a portion ahead of the second core layer. By continuing this formation, second core layer 15a can be extended into resin material 43 cured in a wire shape.

As resin material 43, a mixture of an infrared curable resin and an ultraviolet curable resin is preferably used. Such resin material 43 is filled in a tank connected to capillary 41, and a controlled amount is discharged from the distal end of capillary 41.

Light 45 having the first wavelength is focused on discharged resin material 43 from the outside and is emitted to the discharged resin material in conjunction with the movement of capillary 41. As a result, photonic interconnect 15 is cured from the outer periphery and is formed in a wire shape extending in the air. Light 45 having the first wavelength mainly contributes to the formation of second cladding layer 15b.

Light 45 having the first wavelength is preferably an ultraviolet laser having a wavelength of about 150 nm to 500 nm. In addition, it is preferable to use a femtosecond laser having a pulse width in femtoseconds. When the femtosecond laser is used, it is possible to cure the resin only at the tip end of capillary 41 in which the laser is focused and to avoid curing of the resin in the periphery thereof. Therefore, photonic interconnect 15 can be formed with high accuracy.

Light 44 having the second wavelength is emitted from first core layer 12a of optical waveguide 12. As a result, the central portion of photonic interconnect 15 is cured. Light 44 having the second wavelength mainly contributes to the formation of second core layer 15a.

Light 44 having the second wavelength is preferably an infrared laser having a wavelength of about 1300 nm to 1550 nm. This may be light emitted when photonic device 10 such as the VCSEL operates, or may be light incident from an optical fiber or the like connected to optical waveguide 12.

After completion of photocuring by irradiation of light 45 having the first wavelength and light 44 having the second wavelength, thermal curing may be further performed as necessary. That is, temporary curing may be performed by light to form photonic interconnect 15, and then final curing (post-baking) may be performed by heating to complete photonic interconnect 15. As the post bake, for example, using a hot plate, an oven, or the like, heating is performed in a temperature range from 50° C. to 300° C. for about 1 minute to 120 minutes to complete curing (polymerization).

In the above description, it is described that the capillary that discharges resin material 43 from the distal end is used as the material feeder. However, the material feeder is not limited thereto. For example, a needle may be used. As a needle, a hollow needle with extended distal end such as an injection needle can be used. In this case, the material can be fed by discharging resin material 43 from the distal end similarly to the capillary, and curing of the resin inside can be suppressed by using a needle made of a light-shielding material such as metal. In addition, using a needle having a shape such as a cone or a cylinder that is not a hollow structure as the needle, the material can be fed in a form in which liquid resin material 43 spreads along the surface of the needle. In this case, it is desirable to limit the light irradiation range in order to avoid curing of resin material 43 in the middle of the needle.

Next, a sequence example of photocuring for forming photonic interconnect 15 will be described.

### First Sequence Example

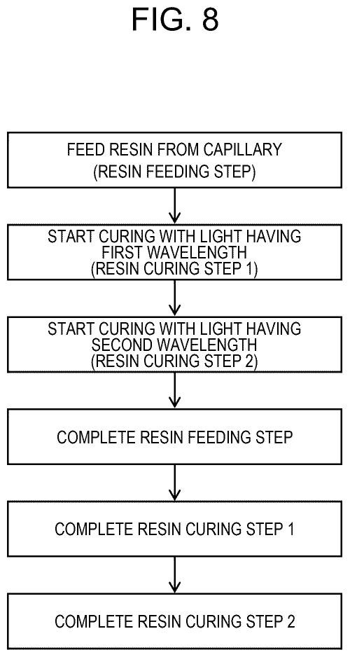

FIG. 8 illustrates a first sequence example. In the first sequence example, first, a resin feeding step of feeding (discharging) resin material 43 from capillary 41 is started. As described above, the position where discharge is started is a position avoiding optical input and output portion 18. Subsequently, a resin curing step 1 of emitting light 45 having the first wavelength while the position of the focal point is moved in conjunction with the movement of capillary 41 to cure discharged resin material 43 into a wire shape is started.

Thereafter, a resin curing step 2 of emitting light 44 having the second wavelength from first core layer 12a to cure the center side of transmission line portion 15d is started. After an assumed amount of resin material 43 is fed, the resin feeding step is completed.

Thereafter, the resin curing step 1 and the resin curing step 2 are sequentially completed. In the above sequence, resin material 43 is cured from the outer periphery by light 45 having the first wavelength, and the uncured center side is cured by light 44 having the second wavelength. As a result, it is possible to realize GI-type photonic interconnect 15 in which the refractive index gradually decreases from the center side toward the outside.

Since second core layer 15a and second cladding layer 15b are integrally formed, the bonding strength is high, and peeling thereof is suppressed.

### Second Sequence Example

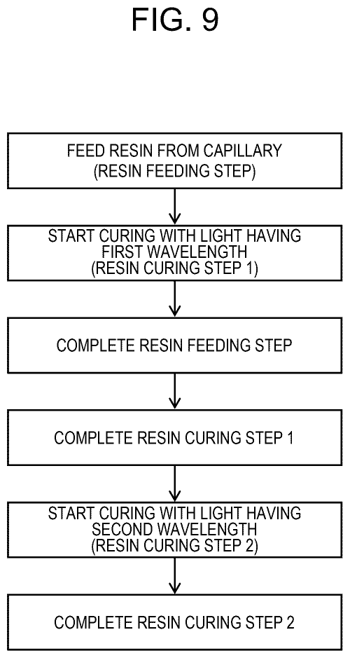

FIG. 9 illustrates a second sequence example. Also in the second sequence example, first, a resin feeding step of feeding (discharging) resin material 43 from capillary 41 is started. Subsequently, the resin curing step 1 of emitting light 45 having the first wavelength while the position of the focal point is moved in conjunction with the movement of capillary 41 to cure discharged resin material 43 is started. Here, the intensity of light 45 having the first wavelength is adjusted so that the center side of a resin feeding step 2 becomes uncured.

Next, after an assumed amount of resin material 43 is fed, the resin feeding step is completed. In addition, after the outer peripheral side of resin material 43 is cured into a wire shape by light 45 having the first wavelength, the resin curing step 1 is completed.

Thereafter, the resin curing step 2 of emitting light 44 having the second wavelength from first core layer 12a to cure the center side of transmission line portion 15d is started. After the center side is cured, the resin curing step 2 is completed. Also in this sequence, it is possible to realize GI-type photonic interconnect 15 in which the refractive index gradually decreases from the center side toward the outside.

Also in this case, the bonding strength between second core layer 15a and second cladding layer 15b is high, and peeling thereof is suppressed.

### Third Sequence Example

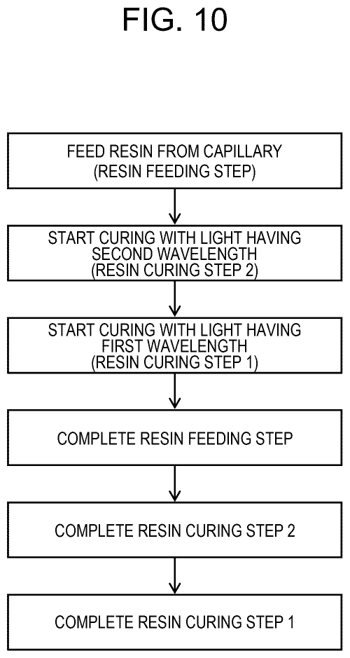

FIG. 10 illustrates a third sequence example. Also in the third sequence example, first, a resin feeding step of feeding (discharging) resin material 43 from capillary 41 is started. Subsequently, in the third sequence example, first, the resin curing step 2 of emitting light 44 having the second wavelength to cure the center side of resin material 43 is started. Subsequently, the resin curing step 1 of emitting light 45 having the first wavelength to cure resin material 43 from the outer peripheral side is started.

After an assumed amount of resin material 43 is fed, the resin feeding step is completed. Thereafter, the resin curing step 2 and the resin curing step 1 are sequentially completed.

In this sequence, second core layer 15a is formed first, and then second cladding layer 15b is formed outside second core layer 15a. In this case, unlike the first sequence and the second sequences, SI-type photonic interconnect 15 having an interface between second core layer 15a and second cladding layer 15b is formed.

The embodiments described above can be modified in form and details without departing from the spirit of the claims. In addition, the contents of each embodiment can be appropriately combined and replaced as long as the functions of the object of the present disclosure are not impaired.

### INDUSTRIAL APPLICABILITY

The strength of connection of the photonic interconnect to the photonic device is improved, and the technique of the present disclosure is useful as an photonic interconnect and an optical transmission module including the photonic interconnect. In addition, the technique of the present disclosure is useful as a method for manufacturing an photonic interconnect with improved connection strength.

### REFERENCE MARKS IN THE DRAWINGS

10: photonic device
11: substrate
12: optical waveguide
12a: first core layer
12b: first cladding layer
15: photonic interconnect
15a: second core layer
15b: second cladding layer
15c: connection portion
15d: transmission line portion
18: optical input and output portion
20: optical transmission module
20a: optical transmission module
20b: optical transmission module
41: capillary (material feeder)
43: resin material
44: light having second wavelength
45: light having first wavelength

1. An photonic interconnect that is formed in an photonic device including an optical waveguide and transmits light emitted from a optical input and output portion included in the optical waveguide, the photonic interconnect comprising:
a connection portion connected to the optical waveguide; and a transmission line portion extending from the connection portion,
wherein, the connection portion is connected to the optical waveguide while avoiding the optical input and output portion, and has a width wider than a width of the transmission line portion.

2. The photonic interconnect according to claim 1,
wherein the optical waveguide includes a first core layer and a first cladding layer covering the first core layer, and
the connection portion of the photonic interconnect is formed on the first cladding layer.

3. The photonic interconnect according to claim 1,
wherein the optical input and output portion is provided on an end surface of the photonic device, and constitutes an edge coupler together with the photonic interconnect.

4. The photonic interconnect according to claim 1,
wherein the optical input and output portion is provided as a diffraction grating on the photonic device, and constitutes a grating coupler together with the photonic interconnect.

5. The photonic interconnect according to claim 1, comprising:
a second core layer; and a second cladding layer covering the second core layer.

6. The photonic interconnect according to claim 5,
wherein the connection portion is formed of the second cladding layer, and
the second core layer is connected to the optical input and output portion.

7. The photonic interconnect according to claim 5,
wherein the second core layer has a higher refractive index than the second cladding layer.

8. The photonic interconnect according to claim 5,
wherein the second core layer and the second cladding layer are formed of resin materials having different curing reactions.

9. The photonic interconnect according to claim 5,
wherein the second core layer is made of a resin that is cured by infrared rays or is cured by a combination of infrared rays and heat, and
the second cladding layer is made of a resin that is cured by ultraviolet rays or is cured by a combination of ultraviolet rays and heat.

10. The photonic interconnect according to claim 5,
wherein the second core layer is made of a resin that is cured by infrared rays or is cured by a combination of infrared rays and heat, and
the second cladding layer is made of a resin that is cured by heat.

11. The photonic interconnect according to claim 5,
wherein a refractive index continuously changes from the second core layer to the second cladding layer.

12. An optical transmission module comprising: an photonic device having the optical waveguide; and the photonic interconnect according to claim 1.

13. A method for manufacturing an photonic interconnect that is formed in an photonic device having an optical waveguide and transmits light emitted from a optical input and output portion of the optical waveguide, the method comprising:
a feeding step of feeding liquid resin materials while moving a material feeder; and
a curing step of sequentially curing the fed resin materials to cure the resin materials in a wire shape extending in the air.
